(19) United States
(12) Patent Application Publication
(10) Pub. No.: US 2016/0092909 A1
(43) Pub. Date: Mar. 31, 2016

(54) Advertising Module

(71) Applicant: ICON Health & Fitness, Inc., Logan, UT (US)

(72) Inventor: Eric S. Watterson, Logan, UT (US)

(21) Appl. No.: 14/503,169

(22) Filed: Sep. 30, 2014

(51) Int. Cl. G06Q 30/02; E04B 1/343; G06Q 90/00

(52) U.S. Cl. CPC G06Q 30/0241; G06Q 90/00; E04B 1/34321

(57) ABSTRACT

A method of advertising includes placing an advertising module on a football field where the advertising module includes a platform, an exercise device positioned on the platform, and an advertisement attached to the platform. The location of the advertising module on the football field is between a goal line and a 25 yard line and proximate a side line of a playing region of the field.

### BACKGROUND

American football is a popular sport for the athletically inclined as well as for patrons of spectator sports. In the college and professional leagues, the football games are often held in stadiums. The objective of the team is to outscore their opponents by either moving the football into the end zone past the goal line or by kicking the football between the goal posts to earn a field goal. Generally, just a portion of the team is actively playing the football game while the rest of the team watches from within the player's box. The player's box is located along the side lines and is located between the 25 yard line on one side of the field and the 25 yard line on the other side of the field. Often, the team receives a penalty if its team members exist the player's box to be along the side lines between the 25 yard line and the goal line.

### SUMMARY

In one aspect of the invention, a method of advertising includes placing an advertising module on a football field where the advertising module includes a platform, an exercise device positioned on the platform, and an advertisement attached to the platform. The location of the advertising module on the football field is between a goal line and a 25 yard line and proximate a side line of a playing region of the field to maximize exposure to the advertising module.

In some examples, the location of the advertising module is proximate the player's box incorporated into the field. The advertisement may be presented on a banner, presented on a digital display, another location of the advertising module, or combinations thereof. The digital display may be connected to at least one breakaway joint of the platform.

The platform may include at least one breakaway point to minimize damage if the players executing a play cross the side lines and impact the advertising module. The platform may include a non-slip surface.

The platform may include multiple panels where at least two of the panels connect to different advertisements, and the multiple panels are angled to present the advertisements in different directions. In some circumstances, the platform comprises a rectangular shape with a first panel on a first side, a second panel on a second side, a third panel on a third side, and a fourth panel on a fourth side.

In another aspect of the invention, an advertising module for a football field includes a platform, an exercise device positioned on the platform, and an advertisement attached to the platform. Such an advertising module may include advertisements presented on a banner, a digital display, another portion of the advertising module, or combinations thereof. In some cases, the advertising module includes at least one breakaway joint. In such circumstances, a digital screen may be connected to the breakaway joint. The platform may also include a non-slip surface.

The platform may include multiple panels where at least two of the panels connect to different advertisements. The multiple panels are angled to present the advertisements in different directions. In other some examples, the platform has a rectangular shape with a first panel on a first side, a second panel on a second side, a third panel on a third side, and a fourth panel on a fourth side. Also, the platform may include a first advertisement attached to the first side, a second advertisement attached to a second side, a third advertisement attached to a third side, and a fourth advertisement attached to a fourth side.

In another aspect of the invention, a method of advertising includes placing an advertising module on a football field. The advertising module includes a platform, an exercise device positioned on the platform, and an advertisement is presented on a digital display that is connected to at least one breakaway joint of the platform. A base of the platform includes a non-slip surface, and the location of the advertising module on the football field is between a goal line and a 25 yard line and proximate a side line of a playing region of the field. Also, the location is proximate a player's box.

Any of the aspects of the invention detailed above may be combined with any other aspect of the invention detailed herein.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a top view of an example of a football field in accordance with the present disclosure.

FIG. 2 illustrates a top view of an example of an advertising module in accordance with the present disclosure.

FIG. 3 illustrates a side view of an example of an advertising module in accordance with the present disclosure.

FIG. 4 illustrates a top view of an example of an advertising module in accordance with the present disclosure.

FIG. 5 illustrates a top view of an example of an advertising module in accordance with the present disclosure.

FIG. 6 illustrates a block diagram of an example of a method for advertising in accordance with the present disclosure.

Throughout the drawings, identical reference numbers designate similar, but not necessarily identical, elements.

### DETAILED DESCRIPTION

The rules typically followed by collegiate and professional football teams confines the players of a football game to the player's box. By confining the players to the player's box, the slide lines adjacent to the goal line are cleared to avoid congestion around the goal line from the players when a touchdown appears likely. The player's box usually spans from the 25 yard line on one side of the playing field to the other 25 yard line on the other side of the playing field. The space adjacent to the side line between the goal line and the 25 yard line at all corners of the field are often open and free of obstacles. This space may be utilized without jeopardizing the purpose of keeping the players out of this space. For example, placing an advertising module at this location may help the football team, school, league, or other entity generate additional revenue during the game. Additionally, this location is prime advertising space because it is not likely to be obscured by coaches or players, and will often appear in the background during exciting or highlight worthy portions of the game. The placement of the advertising module would not congest the areas around the goal lines when scoring appears to be imminent. Additionally, due to the proximity of the location to the goal line, cameras are already set up in the area to gain coverage. Thus, an advertising module within this location can get large amounts of exposure during the game from sideline cameras, overhead cameras, end zone cameras, and fans attending the game. For example, portions of the game can be viewed on a play back screen located within the stadium, and such replays can include images of the advertising module since the advertising module is likely to be in an area of interest. Also, many professional and collegiate football games are televised to local and national markets. Thus, millions of viewers may potentially see the advertising module as they watch the game remotely.

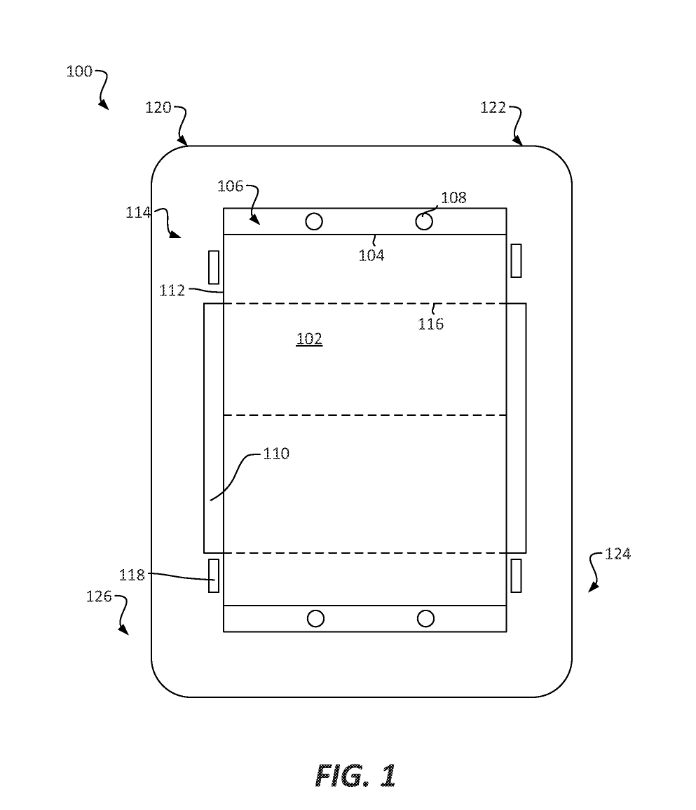

Particularly, with reference to the figures, FIG. 1 depicts a football field 100 with a playing region 102. The playing region 102 includes a goal line 104 and an end zone 106. Further, goal posts 108 are positioned within the end zone 106. A football team may score points when the team moves the ball across the goal line 104 into the end zone 106 or when the ball is kicked between goal posts 108.

Often, just a portion of the team is in the playing region 102 at a time during the game. The remainder of the team players, coaching staff, and other team personnel are within the player's box 110, which is adjacent to the side lines 112. Thus, the space 114 between the goal line 104 and the 25 yard lines 116 where the player's box 110 ends is available for the advertising module 118.

The advertising module 118 may be placed anywhere within the space 114. Thus, the advertising module 118 may be placed adjacent the end zone 106, adjacent the goal line 104, adjacent the 5 yard line, adjacent the 10 yard line, adjacent the 15 yard line, adjacent the 20 yard line, adjacent the 25 yard, adjacent the player's box 110, adjacent another field line, or combinations thereof. The advertising module may be placed on the side line 112, adjacent to the side line 112, or combinations thereof. Further, multiple advertising modules 118 may be located within the space 114. For example, an advertising module 118 may be positioned within the space 114 located at a first corner 120 of the football field 100 and another advertising module 118 may be located in the space 114 at a second corner 122 of the football field 100. In the illustrated example, each of the spaces 114 of the first corner 120, the second corner 122, the third corner 124, and the fourth corner 126 include an advertising module 118. However, in other examples, one of the corners, 120, 122, 124, 126 may include multiple advertising modules 118. For example, the first corner 120 may include two or more advertising modules 118.

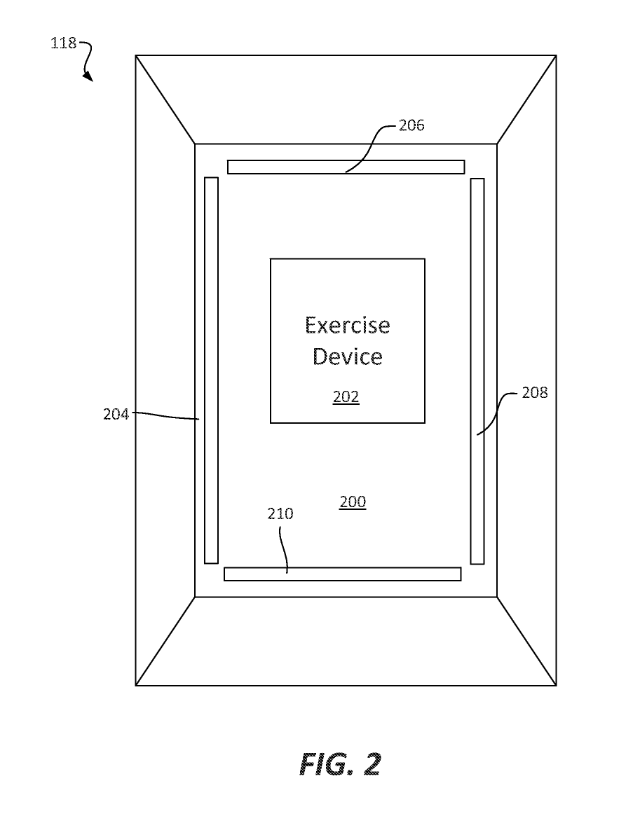

FIG. 2 illustrates a top view of an example of an advertising module 118 in accordance with the present disclosure. In this example, the advertising module 118 includes platform 200 on which an exercise device 202 can rest. The advertising module 118 also includes four sides that are angled that span from the surface of the platform 200 to the ground. The angled sides may reduce the momentum of a player who runs out of bounds or is thrown out of bounds during the game who comes into contact with the advertising module 118. For example, the angled sides may make it easier for the player to run up the side of the advertising module 118 instead of running into a vertical side of advertising module 118 that may be more difficult for the user to maneuver around, especially under the commotion of the play.

The advertising module 118 may also include panels 204, 206, 208, 210 that are capable of supporting advertisements. For example, the panels 204, 206, 208, 210 may be a board, plastic, a frame, another type of structure, or combinations thereof. Further, the panels 204, 206, 208, 210 may include hooks, clips, snaps, ties, other types of fasteners, or combinations thereof that can be used to secure advertisements.

The panels 204, 206, 208, 210 may be positioned to present the advertisements in multiple directions. In the illustrated example, the first panel 204 faces in a first direction, the second panel 206 faces in a second direction, the third panel 208 faces in a third direction, and the fourth panel 210 faces in a fourth direction. In this example, the different directions present the advertisements to different groups of people within the football stadium. For example, one of the panels may present an advertisement to the spectators on the same side of the stadium as the advertising module 118 while another one of the panels presents the advertisements to another group of spectators on the opposing side of the stadium. Additionally, advertisements may be placed on the bottom surface of the platform to allow for advertisements to be seen from overhead photographs and videos.

For the purposes of this disclosure, an advertisement may include any appropriate medium that displays information about a product or service. Such information may include company logos, product information, service information, images of products, images depicting services, mascots, written words, symbols, images, colors, other types of media that may be associated with a business, a product, a service, an initiative, a political proposition, a non-profit, an organization, an entity, another type of group, or combinations thereof. The advertisement may be incorporated into a banner, a sign, paper, a canvas, a backlit structure, plastic, a digital screen, another type of material, another type of structure, or combinations thereof.

In some circumstances, the exercise device 202 may be related to the advertisements. For example, the advertisements may display a company logo of the company the sells, makes, manufactures, and/or distributes the exercise device 202.

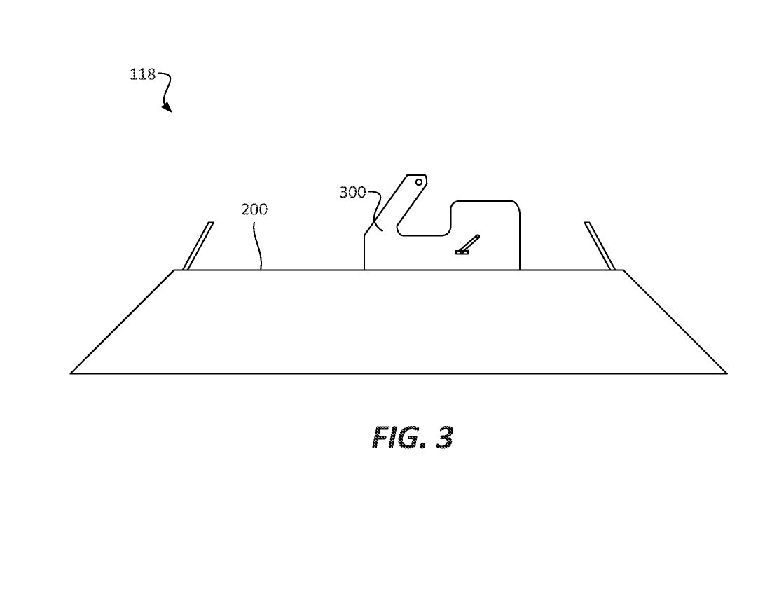

FIG. 3 illustrates a side view of an example of an advertising module 118 in accordance with the present disclosure. In this example, the advertising module 118 includes a stationary bike 300 located on the platform 200. Further, this example includes a first panel 204 and a second panel 206 with advertisements attached.

The angled sides of the advertising module 118 may include a non-slip surface which may assist when players are trying to maneuver around the advertising module 118. For example, the player may easily run up onto the platform 200 instead of trying to reduce his speed. In other examples, the advertising module 118 includes padding, rounded corners, and/or other features that may assist the players to maneuver around the platform or at least reduce momentum.

During the football game, a user may be positioned on the stationary bike or exercise device 202. Such a user may use the stationary bike 300 as a result from a challenge issued by one of the teams mascots, cheerleaders, sponsors, or another type of organized challenge. While this example depicts the exercise device as a stationary bike 300, any appropriate type of exercise device may be used. For example, the exercise device may be a treadmill, a weight set, a rowing machine, a pec dec, a cable pull machine, a stepper machine, dumbbells, jump ropes, another type of exercise device, or combinations thereof.

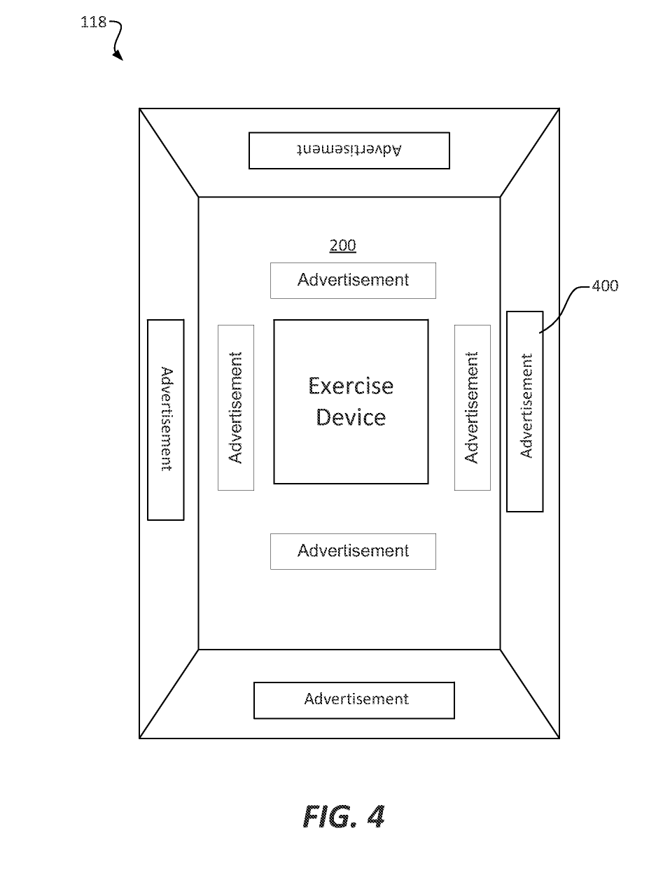

FIG. 4 illustrates a top view of an example of an advertising module in accordance with the present disclosure. In this example, the advertising module 118 includes advertisements 400 incorporated into the angled sides of the platform 200. In such an example, the angle sides of the platform 200 may be any appropriate angle that allows the spectators in the stadium or the viewing audience to view the advertisements. In some examples, the advertisements may be painted, adhered, fastened, or otherwise attached to the angled sides of the platform 200.

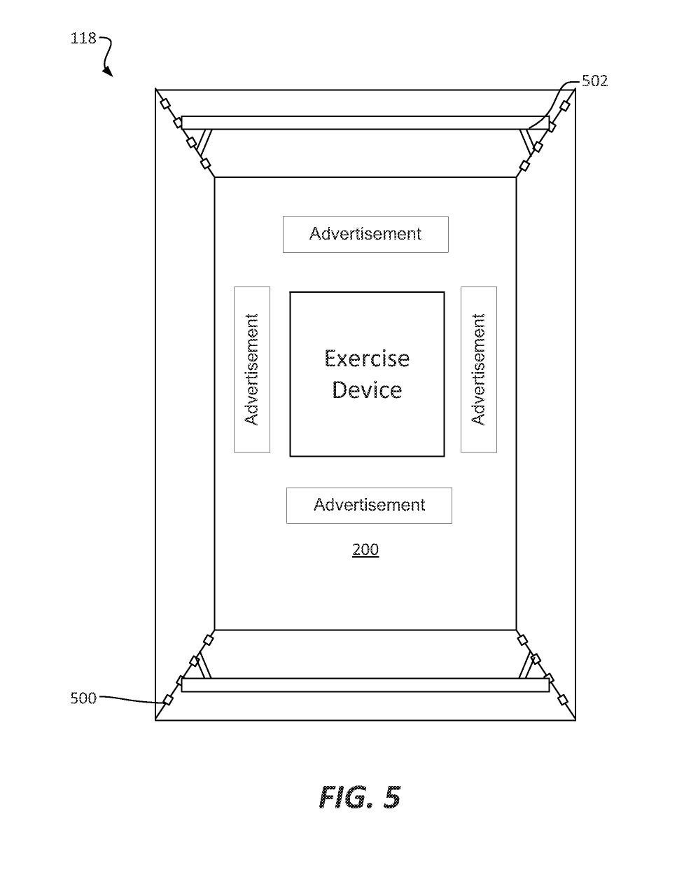

FIG. 5 illustrates a top view of an example of an advertising module 118 in accordance with the present disclosure. In this example, the angled sides of the platform 200 are attached with breakaway fasteners 500 that are constructed to break under an impact of a predetermined load. Such a load may include the typical types of forces that are involved when a player runs into or is thrown into the platform 200. By allowing the platform 200 to collapse under such loads if a player were to be inadvertently thrown into the advertising module 118 as a result of a play during the game, the force of the impact between the player and the advertising module 118 may be reduced. Further, the advertising module 118 may receive less damage because only the cheaper breakaway features of the advertising module 118 break under such loads while the rest of the structures remain uncompromised.

In the illustrated example, the advertising module 118 also includes digital screens 502. Such digital screens 502 may be attached to any appropriate location on the advertising module 118, such as the platform 200, the angled sides, the joints between the angled sides, other locations, or combinations thereof. In the example of FIG. 5, the digital screens 502 are attached at the breakaway joints.

Any appropriate type of breakaway features may be incorporated into the advertising module 118. For example, the breakaway features may include using a material that easily breaks at certain threshold of force when maintaining a sufficient amount of strength under that threshold. In some examples, the breakaway features may be constructed to carry heavy loads in a first direction, but break easily in a second direction. For example, the breakaway features may be constructed to hold the expected loads of the exercise device, and users walking on the platform. However, such breakaway features may break easily when a lateral load is applied to the advertising module 118.

The digital screens 502 may be used to show static images of advertisements. However, in other examples, the digital screens 502 may be used to show videos of the companies, products, services, etc. for which they are advertising. Further, the digital screens 502 may also present advertisements for multiple sponsors at different times during the game. In some examples, the digital screens 502 may also present images from the game, replays, news, other events, or combinations thereof.

While the above examples have been depicted with specific examples that depict a specific number of panels, displays, and advertisements, any appropriate number of panels, displays, and/or advertisements may be used. For example, the advertising module 118 may include a single panel, display, or advertisement. Likewise, the advertising module 118 may any number of panels, displays, and/or advertisements. Further, the advertising module 118 may include multiple types of media for advertising. In such an example, the advertising module 118 may include a backlight device for presenting a first advertisement, a banner presenting a second advertisement, and a digital screen for presenting a third advertisement.

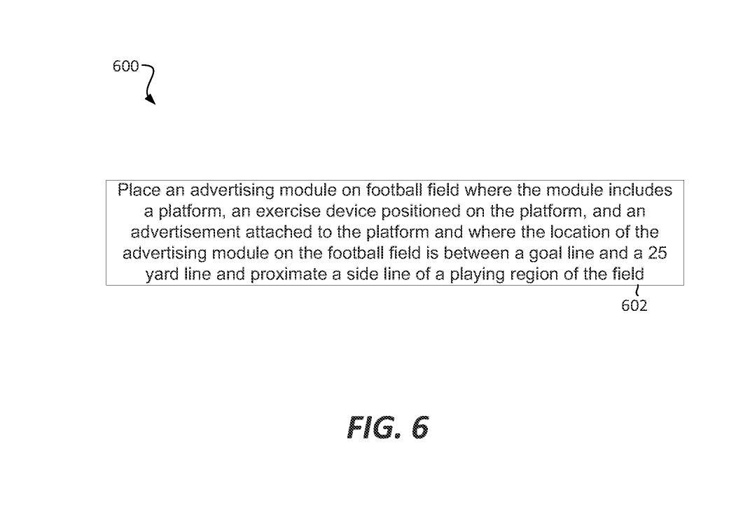

FIG. 6 illustrates a block diagram of an example of a method for advertising in accordance with the present disclosure. In this example, the method 600 includes, at 602, placing an advertising module on football field where the module includes a platform, an exercise device positioned on the platform, and an advertisement attached to the platform and where the location of the advertising module on the football field is between a goal line and a 25 yard line and proximate a side line of a playing region of the field.

In this example, the location of the advertising modules may be associated with any corner of the field. The advertising modules may be viewed by the spectators present in the football stadium during the game. Additionally, the advertising modules may also be viewed by audiences watching the football game over a televised program. In those examples, where there are multiple advertisements presenting the advertisements in multiple directions, the camera angles capturing events in the playing region of the football field have a high likelihood of capturing images of the advertisements especially since the space between the goal line and the 25 yard line often include plays of high interest due to their proximity to the goal line. Thus, the location of the advertising modules may allow not just the thousands of spectators in the stadium, but the location may allow millions of views throughout the country and perhaps internationally as well. In such cases, the presentation angle of the advertisements may be varied to optimize view ability of the advertisements.

While the examples above have been described with reference to a specific location in the football field, the advertising modules may also be located at other locations at or around the football field. For example, a sponsor may have an advertising module at the space as described above as well as at a booth located nearby the field.

Also, while the examples above have been described with reference to the advertising modules having a specific structure, the advertising module may include any appropriate type of structure. For example, the advertising module may be built out of a box structure, a sled, a permanent structure, another type of structure, or combinations thereof.

What is claimed is:

1. A method of advertising, comprising:
placing an advertising module at a location on a football field, where the advertising module includes:
a platform;
an exercise device positioned on the platform; and
an advertisement attached to the platform;
wherein the location of the advertising module on the football field is between a goal line and a 25 yard line and proximate a side line of a playing region of the football field.

2. The method of claim 1, wherein the location is proximate a player's box incorporated into the football field.

3. The method of claim 1, wherein the advertisement is presented on a banner.

4. The method of claim 1, wherein the advertisement is presented on a digital display.

5. The method of claim 4, wherein the digital display is connected to at least one breakaway joint of the platform.

6. The method of claim 1, wherein the platform includes at least one breakaway joint.

7. The method of claim 1, wherein a base of the platform includes a non-slip surface.

8. The method of claim 1, wherein the platform includes multiple panels, where at least two of the multiple panels connect to different advertisements, wherein the multiple panels are angled to present the advertisements in different directions.

9. The method of claim 1, wherein the platform comprises a rectangular shape with a first panel on a first side, a second panel on a second side, a third panel on a third side, and a fourth panel on a fourth side.

10. The method of claim 1, wherein a first advertisement is attached to a first side, a second advertisement is attached to a second side, a third advertisement is attached to a third side, and a fourth advertisement is attached to a fourth side.

11. An advertising module for a football field, comprising:
a platform;
an exercise device positioned on the platform; and
an advertisement attached to the platform.

12. The advertising module of claim 11, wherein the advertisement is presented on a banner.

13. The advertising module of claim 11, wherein the advertisement is presented on a digital display.

14. The advertising module of claim 13, wherein the digital display is connected to at least one breakaway joint of the platform.

15. The advertising module of claim 11, wherein the platform includes at least one breakaway joint.

16. The advertising module of claim 11, wherein a base of the platform includes a non-slip surface.

17. The advertising module of claim 11, wherein the platform includes multiple panels, where at least two of the multiple panels connect to different advertisements, wherein the multiple panels are angled to present the advertisements in different directions.

18. The advertising module of claim 11, wherein the platform comprises a rectangular shape with a first panel on a first side, a second panel on a second side, a third panel on a third side, and a fourth panel on a fourth side.

19. The advertising module of claim 11, wherein a first advertisement is attached to a first side, a second advertisement is attached to a second side, a third advertisement is attached to a third side, and a fourth advertisement is attached to a fourth side.

20. A method of advertising, comprising:
placing an advertising module at a location on a football field, where the advertising module includes:
a platform;
an exercise device positioned on the platform; and
an advertisement is presented on a digital display that is connected to at least one breakaway joint of the platform; and
a base of the platform includes a non-slip surface;
wherein the location of the advertising module on the football field is between a goal line and a 25 yard line and proximate a side line of a playing region of the football field and wherein the location is proximate a player's box.
